(19) United States
(12) Patent Application Publication
(10) Pub. No.: US 2020/0100344 A1
(43) Pub. Date: Mar. 26, 2020

(54) ILLUMINATION SYSTEM AND METHOD FOR SETTING UP ILLUMINATION SYSTEM

(71) Applicant: PANASONIC INTELLECTUAL PROPERTY MANAGEMENT CO., LTD., Osaka (JP)

(72) Inventor: Tetsuya TANIGAWA, Hyogo (JP)

(73) Assignee: PANASONIC INTELLECTUAL PROPERTY MANAGEMENT CO., LTD., Osaka (JP)

(21) Appl. No.: 16/567,433

(22) Filed: Sep. 11, 2019

(30) Foreign Application Priority Data
Sep. 20, 2018 (JP) 2018-175927

(51) Int. Cl. H05B 37/02

(52) U.S. Cl. CPC H05B 37/0245; H05B 37/029

(57) ABSTRACT

An illumination system disposes a plurality of first luminaires that are virtual, virtually simulates a lighting mode for each of the plurality of first luminaires, and uses information from a first information processing device that generates lighting information indicating the lighting mode for each of the plurality of first luminaires and DMX addresses that are linked to the lighting information and identify each of the plurality of first luminaires. The illumination system includes a plurality of second luminaires disposed in an actual facility, and a console that turns on each of the plurality of second luminaires in a predetermined lighting mode. The console obtains the lighting information, the DMX addresses, and unique IDs that identify each of the plurality of second luminaires; and further obtains setup information in which the DMX addresses and the unique IDs are linked.

### CROSS REFERENCE TO RELATED APPLICATION

This application claims the benefit of priority of Japanese Patent Application Number 2018-175927 filed on Sep. 20, 2018, the entire content of which is hereby incorporated by reference.

### BACKGROUND

### 1. Technical Field

The present disclosure relates to an illumination system and a method for setting up the illumination system.

### 2. Description of the Related Art

A console that controls luminaires is disposed in studios and on stages. The console performs dimming control and toning control for the luminaires disposed in studios, on stages, etc. in accordance with a standard called Digital Multiplex (DMX).

Conventionally, a console has been disclosed that includes a memory unit that stores information about the luminaires, an identifying unit that identifies the information about the disposed luminaires from the information stored in the memory unit, and a display that displays the information identified by the identifying unit (see Japanese Unexamined Patent Application Publication No. 2017-107736).

When setting up a lighting mode for the actual luminaires, the task of individually setting up DMX addresses of the luminaires is performed on-site in studios, on stages, etc. In other words, it is difficult for the console to turn on each of the luminaires in a desired lighting mode when the DMX addresses of each of the luminaires are not set up on the spot. Accordingly, it is necessary to set up each DMX address while checking which DMX address is linked to which luminaire, causing the setting up of lighting scenes to take time and effort.

Accordingly, the present disclosure aims to provide an illumination system and a method for setting up the illumination system that makes it possible to easily set up lighting modes of the illumination system.

### SUMMARY

An illumination system according to an aspect of the present disclosure (i) disposes a plurality of first luminaires that are virtual, (ii) virtually simulates a lighting mode for each of the plurality of first luminaires, (iii) uses information from a first information processing device that generates lighting information indicating the lighting mode for each of the plurality of first luminaires and first address information that is linked to the lighting information and identifies each of the plurality of first luminaires, (iv) includes a plurality of second luminaires disposed in an actual facility and a console that turns on each of the plurality of second luminaires in a predetermined lighting mode. The console obtains the lighting information, the first address information, and second address information that identifies each of the plurality of second luminaires; and further obtains setup information in which the first address information and the second address information are linked.

A method for setting up the illumination system according to an aspect of the present disclosure includes using information from a first information processing device that (i) disposes a plurality of first luminaires that are virtual, (ii) virtually simulating a lighting mode for each of the plurality of first luminaires, and (iii) generates lighting information indicating the lighting mode for each of the plurality of first luminaires and first address information that is linked to the lighting information and identifies each of the plurality of first luminaires; turning on a plurality of second luminaires that are disposed in an actual facility in a predetermined lighting mode; obtaining the lighting information, the first address information, and second address information that identifies each of the plurality of second luminaires; and further obtaining setup information in which the first address information and the second address information are linked.

The illumination system and the method for setting up the illumination system in the present disclosure make it possible to easily set up lighting modes of the illumination system.

### BRIEF DESCRIPTION OF DRAWINGS

The figures depict one or more implementations in accordance with the present teaching, by way of examples only, not by way of limitations. In the figures, like reference numerals refer to the same or similar elements.

FIG. 1 is a block diagram exemplifying a first console, a first information processing device, a second console, a second information processing device, and second luminaires according to an embodiment;

FIG. 2 is a schematic view exemplifying a setup screen on a display of a first information processing device according to the embodiment;

FIG. 3 is a diagram exemplifying lighting information about first luminaires set up by the first information processing device according to the embodiment;

FIG. 4 is a flowchart exemplifying a method for setting up an illumination system according to the embodiment;

FIG. 5A is a diagram exemplifying unique IDs that the second information processing device has obtained from the second luminaires, and DMX addresses of the first luminaires according to the embodiment; and

FIG. 5B is a schematic view exemplifying a setup screen on a display of a second information processing device according to the embodiment.

### DETAILED DESCRIPTION OF THE EMBODIMENTS

Hereinafter, embodiments will be concretely described with reference to the drawings. Note that the embodiments described below each show a specific example in the present disclosure. Numerical values, shapes, materials, components, placement and connection of the components, steps and their order, and the like are mere examples and are not intended to limit the present disclosure. Components in the following embodiments not mentioned in any of the independent claims that define the broadest concepts are described as optional elements.

Note that the drawings are schematic diagrams and do not necessarily provide strictly accurate illustrations. Moreover, in the drawings, components that are substantially the same as components described previous thereto have the same reference numerals and overlapping descriptions are omitted or simplified.

Hereinafter, an illumination system and a method for setting up the illumination system in the present disclosure will be described.

### Embodiment

### Configuration

Illumination system 1 according to the present embodiment will be described first.

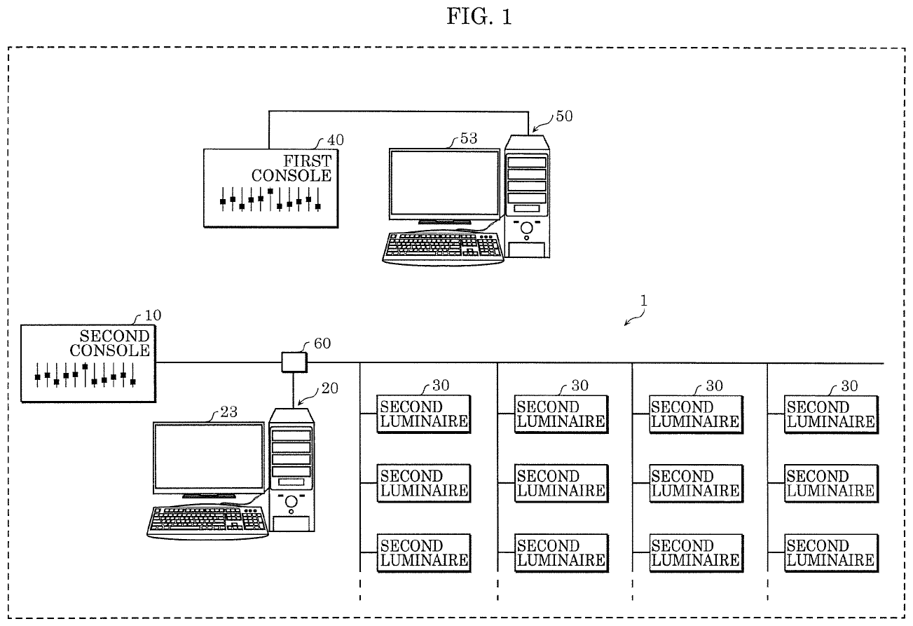

FIG. 1 is a block diagram exemplifying first console 40, first information processing device 50, second console 10, second information processing device 20, and second luminaires 30 according to the embodiment.

As illustrated in FIG. 1, illumination system 1 turns on luminaires disposed in a studio, on a stage, etc. in a predetermined lighting mode for performances in a studio, on a stage, etc. In illumination system 1, lighting information that indicates a lighting mode for virtual first luminaires is pregenerated. Illumination system 1 directs the illumination so that second luminaires 30 are caused to be turned on in the predetermined lighting mode by feeding the pregenerated lighting information to a console disposed in a studio, on stage, etc.

The lighting mode is an illumination state in which the luminaires (hereinafter, general term for the first luminaires and second luminaires 30) are directed in unison through the combination of the light's brightness, hue, contrast, etc. when the luminaires are turned on and causing the luminaires to be repeatedly turned on and off for a predetermined period.

Illumination system 1 sets up second luminaires 30 so that second luminaires 30 are turned on in the predetermined lighting mode using first console 40 and first information processing device 50 to which first console 40 is connected.

First information processing device 50 is, for example, a computer. First information processing device 50 is connected to first console 40 via a communication cable using a Digital Multiplex (DMX) protocol called DMX512 in which bidirectional communication is possible. First information processing device 50 is an example of an information processing device.

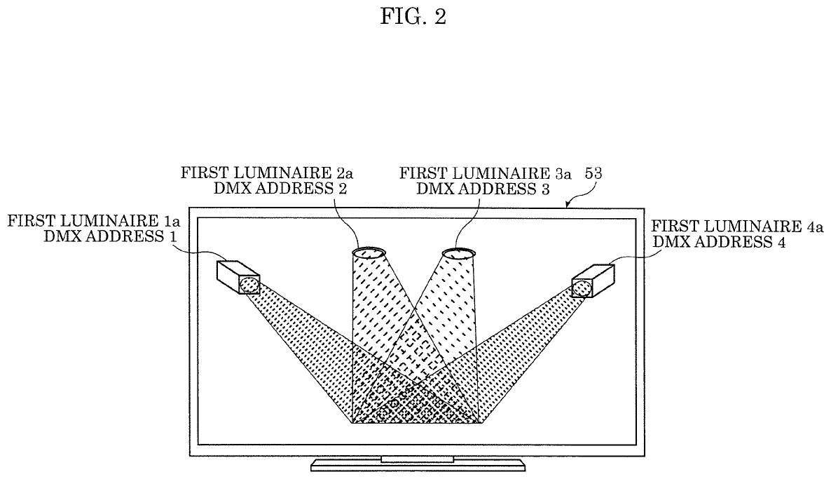

An image displayed by first information processing device 50 will be described with reference to FIG. 2. FIG. 2 is a schematic view exemplifying a setup screen displayed on display 53 of first information processing device 50 according to the embodiment.

As illustrated in FIG. 2, first information processing device 50 disposes virtual first luminaires 1a to 4a using software, and virtually simulates a lighting mode for each of first luminaires 1a to 4a. In other words, software that can dispose the virtual first luminaires 1a to 4a by a user operation, generate an image virtually simulating the lighting mode for each of first luminaires 1a to 4a, and display the generated image on display 53 is installed on a memory device in first information processing device 50. In other words, the software can simulate the lighting mode for first luminaires 1a to 4a. Note that since the user knows the type, number, and placement positions of second luminaires 30 disposed in a facility, the user can dispose the virtual first luminaires 1a to 4a. Note that the image is not only a still image, but also includes a moving image.

In the present embodiment, first information processing device 50 is disposed in a place different from a studio, stage, etc. Through an operation of first console 40 by the user, the image that virtually simulates the lighting mode for first luminaires 1a to 4a is generated and the generated image is displayed on display 53 in accordance with the operation.

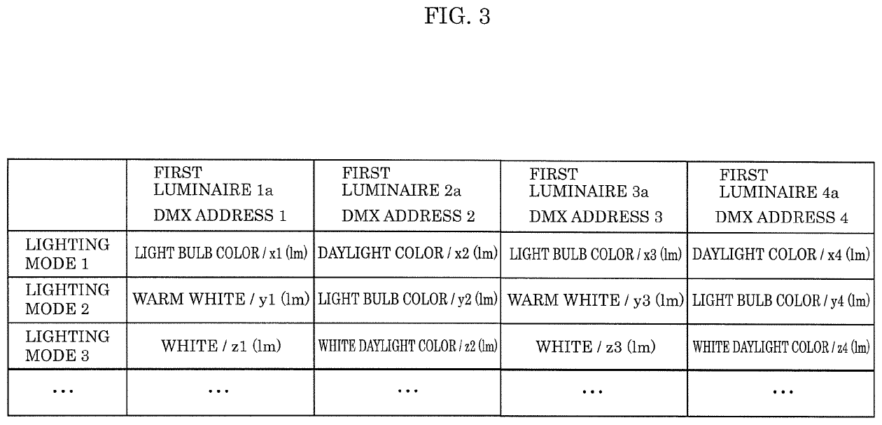

To be specific, as illustrated in FIG. 2 and FIG. 3, the user operates first information processing device 50, virtually disposes first luminaires 1a to 4a, and sets up the lighting mode for each first luminaires 1a to 4a (FIG. 3) by operating first console 40. By doing so, first information processing device 50 obtains lighting information that implements the lighting mode indicated by the image displayed on display 53 in accordance with the operation of first console 40 by the user. The user, for example, operates first console 40 while checking the image displayed on display 53, and saves the setup by operating first console 40 when an image that indicates a desired lighting mode is displayed. With this, first information processing device 50 obtains the lighting information. Note that the lighting information may be generated by first console 40, and may also be generated by first information processing device 50. FIG. 3 is a diagram exemplifying the lighting information about the first luminaires set up by first information processing device 50 according to the embodiment.

As illustrated in FIG. 1, display 53 is, for example, a monitor connected to first information processing device 50. The first luminaires are virtual luminaires that the software displays on display 53, and various luminaires are stored in the memory device of first information processing device 50 as the first luminaires.

First console 40 is used when setting up the lighting mode for first luminaires that the software, which is installed on first information processing device 50, displays. First console 40 includes input devices called faders. The slider position of each of the faders corresponds to the brightness and contrast of red, green, and blue light. First console 40 generates an output value for each of the red, green, and blue light (lighting information) based on the slider position of each of the faders operated by the user, and transmits the generated lighting information to first information processing device 50.

A configuration of illumination system 1 will be described next. Illumination system 1 includes second luminaires 30 and second console 10.

Second luminaires 30 are disposed in an actual facility, e.g. in a studio, on stage, etc. Second luminaires 30 are connected to first console 40 via a communication cable and switching hub 60 using a DMX protocol such as DMX512 in which bidirectional communication is possible.

Each of second luminaires 30 can emit light with adjusted brightness, hue, and contrast. Second luminaires 30 include, for example, light sources made up of a red light-emitting diode (LED), green LED, and blue LED. Second luminaires 30 can emit light indicated by a chromaticity diagram due to the light output ratio of the red LED, green LED, and blue LED being adjusted by a control circuit.

Note that second luminaires 30 can also emit dimmed light by changing the dimming ratio and emit toned light by changing the toning ratio due to the light output of the light sources included in second luminaires 30 being controlled through a dimming circuit and a toning circuit. Second luminaires 30, for example, include light sources with a different color temperature made up of a blue LED and yellow phosphor, and can also tone the light by changing the color temperature of the output light due to light output ratio of each light source being controlled by the toning circuit.

Second console 10 obtains setup information generated based on the lighting information. The obtaining of the setup information will be described later. Second console 10 turns on second luminaires 30 in the predetermined lighting mode based on a control command indicated in the setup information so that the first luminaires are turned on in a virtual lighting mode. Second console 10 transmits, via a communication cable, the DMX protocol control command using the DMX512 standard and the like. Second luminaires 30 receive the control command transmitted from second console 10 with a control circuit, and can control the light emitted from the light sources via the control circuit. Second console 10 includes input devices called faders, similar to first console 40. Second console 10 is an example of a console.

### Operation

An operation of illumination system 1 and a method for setting up illumination system 1 will be described next.

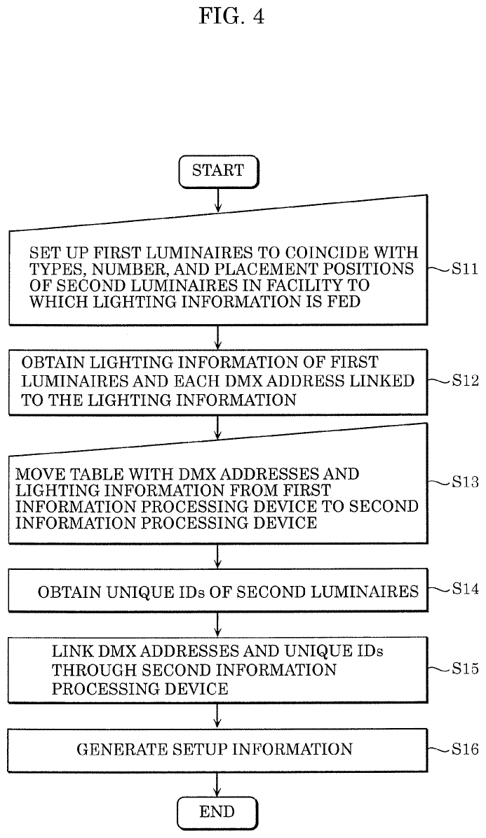

FIG. 4 is a flowchart exemplifying the method for setting up illumination system 1 according to the embodiment.

As illustrated in FIG. 4, the user first operates first console 40 and first information processing device 50, and generates the lighting information that indicates the lighting mode for the first luminaires. To be specific, as illustrated in FIG. 2, the user operates first information processing device 50 so that the type, number and placement positions of second luminaires 30 are simulated in the facility in which the lighting information is fed, and sets up the virtual first luminaires 1a to 4a (S11).

Since each DMX address of second luminaires 30 disposed in the facility may possibly change, the user generally cannot know what type of environment they will be in. Accordingly, a temporary DMX address is preallocated to each of first luminaires 1a to 4a. The DMX address is an example of first address information.

In the present embodiment, first luminaires 1a to 4a are assigned to correspond to DMX addresses 1 to 4. A DMX address is information that identifies one first luminaire, and is a control address used when first console 40 controls the first luminaires.

As illustrated in FIG. 4, the user next operates first console 40 and sets up the lighting mode for each of the first luminaires while looking at the image displayed on display 53 of first information processing device 50 (image that virtually simulates the lighting mode for first luminaires 1a to 4a). First information processing device 50 obtains the lighting information indicating the lighting mode for each of the first luminaires, and DMX addresses that identify the first luminaires due to the user setting up all of the first luminaires (S12). The lighting information of the first luminaires and the DMX addresses are associated one-to-one.

For example, FIG. 3 is a table in which the light color temperature, brightness, etc. are set up per first luminaire. In FIG. 3, the lighting information that indicates the lighting mode and each of the first luminaires are linked. Note that it is not illustrated, but the lighting information may also include information that indicates the time that each of the first luminaires is turned on, turned off, etc.

Next, the user inputs (copies) the table with the DMX addresses and the lighting information (example of information about the first information processing device) obtained by first information processing device 50 to second information processing device 20 disposed in the facility the information is fed to (S13). For example, the user saves the table with the DMX addresses and the lighting information (information about the first information processing device) on a recording medium such as a USB memory, and the table with the DMX addresses and the lighting information is stored in a memory device of second information processing device 20 by causing the table with the DMX addresses and the lighting information to be moved to second information processing device 20.

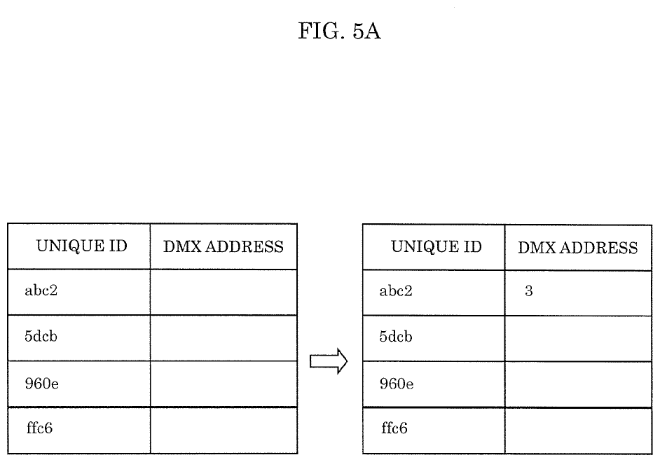

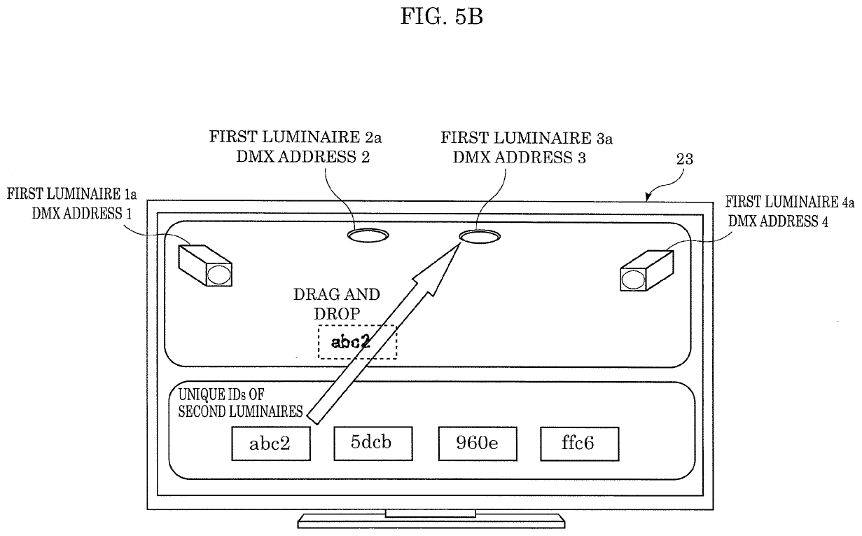

Second information processing device 20 is connected to second luminaires 30 via a communication cable and switching hub 60 using a Remove Device Management (RDM) protocol. As illustrated in the left diagram of FIG. 5A, second information processing device 20 obtains each unique ID (also referred to as UID) of second luminaires 30 from second luminaires 30 (S14). Since the DMX addresses linked to the lighting information are not linked to each unique ID of second luminaires 30, second console 10 cannot control second luminaires 30 with this lighting information. The unique ID is an example of second address information. FIG. 5A is a diagram exemplifying unique IDs that second information processing device 20 has obtained from second luminaires 30, and each DMX address of the first luminaires according to the embodiment.

Second information processing device 20 links the DMX addresses and unique IDs by a user operation (input) so that the first luminaires and second luminaires 30 are associated one-to-one (S15). Second information processing device 20 communicates with second luminaires 30 using the RDM protocol when linking the DMX addresses and the unique IDs of second luminaires 30. To be specific, as illustrated in FIG. 5B, display 23 connected to second information processing device 20 displays a setup screen including each DMX address of the first luminaires linked to the lighting information and each unique ID of second luminaires 30. For example, when the user selects unique ID “abc2” on display 23, the user recognizes the positions of the flashing second luminaires 30 indicated by unique ID “abc2” due to the actual second luminaires 30 flashing. The user drags and drops unique ID “abc2” to the first luminaire (here, first luminaire 3a) that is in the same position as the flashing second luminaires 30 shown in the setup screen on display 23. By doing so, as illustrated in the right drawing of FIG. 5A, second information processing device 20 links DMX address 3 of first luminaire 3a and unique ID “abc2”. The user performs this operation only for the same number of first luminaires. FIG. 5B is a schematic view exemplifying a setup screen displayed on display 23 of second information processing device 20 according to the embodiment.

Second information processing device 20 generates, using the lighting information and the unique IDs, the setup information in which the DMX addresses and the unique IDs are linked so as to be associated one-to-one, and transmits the generated setup information to second console 10. Second console 10 obtains the setup information. By doing so, second console 10 communicates with second luminaires 30 using the DMX protocol based on the setup information, and turns on second luminaires 30 in the predetermined lighting mode. In other words, the setup information can turn on second luminaires 30 in a lighting mode set up in first information processing device 50 by second console 10.

In this manner, in illumination system 1, when the user operates second console 10 based on the setup information, second luminaires 30 start a lighting scene indicated by the lighting modes as illustrated in FIG. 3. For example, second luminaires 30 operate for X seconds in lighting mode 1, and after that for Y seconds in lighting mode 2.

### Advantageous Effects

Advantageous effects of illumination system 1 and the method for setting up illumination system 1 in the present embodiment will be described next.

As stated above, illumination system 1 according to the present embodiment uses information from first information processing device 50 that (i) disposes a plurality of first luminaires that are virtual, (ii) virtually simulates a lighting mode for each of the plurality of first luminaires, and (iii) generates lighting information indicating the lighting mode for each of the plurality of first luminaires and DMX addresses that are linked to the lighting information and identify each of the plurality of first luminaires, and (iv) includes second luminaires 30 disposed in an actual facility and second console 10 that turns on each of second luminaires 30 in a predetermined lighting mode. Second console 10 obtains the lighting information, the DMX addresses, and unique IDs that identify each of the plurality of second luminaires; and further obtains setup information in which the DMX addresses and the unique IDs are linked.

In this illumination system 1, second console 10 can obtain (i) the lighting information that virtually simulates the lighting mode for first luminaires, the DMX addresses, and the unique IDs, and (ii) the setup information in which the DMX addresses and the unique IDs are linked. In this illumination system 1, the lighting mode for second luminaires 30 can be, therefore, easily set up.

The method for setting up illumination system 1 according to the present embodiment uses information from first information processing device 50 that (i) disposes a plurality of first luminaires that are virtual, (ii) virtually simulates a lighting mode for each of the plurality of first luminaires, and (iii) generates lighting information indicating the lighting mode for each of the plurality of first luminaires and DMX addresses that are linked to the lighting information and identify each of the plurality of first luminaires; turning on second luminaires 30 that are disposed in an actual facility in a predetermined lighting mode; obtaining the lighting information, the DMX addresses, and unique IDs that identify each of second luminaires 30; and further obtaining setup information in which the DMX addresses and the unique IDs are linked.

This method also produces the above advantageous effects.

Illumination system 1 according to the present embodiment may further include first information processing device 50.

This illumination system 1 also produces the above advantageous effects.

In illumination system 1 according to the present embodiment, in the setup information, the DMX addresses and the unique IDs are linked by a user input so that the plurality of first luminaires and second luminaires 30 are associated one-to-one.

This configuration enables second luminaires 30 to be turned on in the same lighting mode as the lighting mode indicated in the lighting information set up in advance since the user links the DMX addresses and the unique IDs. In an actual facility, the workload of the user doing the setup work will not easily increase since the DMX addresses and the unique IDs are linked.

Illumination system 1 according to the present embodiment further includes second information processing device 20. Second luminaires 30 are connected to second information processing device 20 that generates the setup information. Second information processing device 20 communicates with second luminaires 30 using the RDM protocol when linking the DMX addresses and the unique IDs of second luminaires 30. Second console 10 communicates with each of second luminaires 30 using a DMS protocol when turning on each of second luminaires 30 based on the setup information.

This configuration enables second console 10 to communicate for performing the lighting control of second luminaires 30 even when second luminaires 30 are various types of devices in the facility since the RDM protocol and the DMX protocol are communication protocols used worldwide.

In illumination system 1 according to the present embodiment, second console 10 turns on second luminaires 30 based on the setup information so that the plurality of the first luminaires are turned on in a virtual lighting mode.

This configuration enables second console 10 to turn on second luminaires 30 in the desired lighting state based on the setup information.

In illumination system 1 according to the present embodiment, illumination system 1 is connected to display 23. Display 23 displays a setup image for linking the DMX addresses and the unique IDs.

This configuration enables the user to easily link the DMX addresses and the unique IDs while looking at the setup image displayed on display 23.

In illumination system 1 according to the present embodiment, second information processing device 20 generates the setup information in which the first address information and the second address information are linked by a user input so that the plurality of first luminaires and second luminaires 30.

Illumination system 1 according to the present embodiment that uses, through first information processing device 50 (example of a computer), specification information including (i) lighting information that indicates a lighting mode for each of a plurality of first luminaires that are virtual and (ii) first address information that identifies each of the plurality of first luminaires. Illumination system 1 includes second luminaires 30 disposed in an actual facility, and second console 10 that turns on each of second luminaires 30 in a predetermined lighting mode. First information processing device 50 disposes the plurality of first luminaires in a virtual space; generates the lighting information by virtually simulating the lighting mode for each of the plurality of first luminaires in the virtual space; and generates the first address information by linking the lighting information and the plurality of first luminaires that use the lighting information. Second console 10 obtains the lighting information, the first address information, and second address information that identifies each of second luminaires 30 from first information processing device 50; and further obtains setup information, in which the first address information and the second address information are linked, so that an operation of each of the plurality of first luminaires and an operation of each of second luminaires 30 are associated with each other.

### Other Embodiments

The present disclosure has been described above based on the embodiment, but the present disclosure is not limited to the above illumination system and the method for setting up the illumination system.

For example, in the above embodiment, the illumination system includes second luminaires 30 and second console 10, but may also further include at least one of first information processing device 50 and second information processing device 20. The illumination system according to each of the above embodiments includes first information processing device 50 that disposes a plurality of virtual first luminaires on a screen and virtually simulates a lighting mode for each of the plurality of the first luminaires, second luminaires second luminaires 30 disposed in an actual facility, and second console 10 that turns on second luminaires 30 in a predetermined lighting mode. First information processing device 50 obtains the lighting information that indicates the lighting modes for the plurality of first luminaires and the DMX addresses that identify the plurality of first luminaires. Second console 10 obtains the lighting information and the DMX addresses from first information processing device 50, the unique IDs that identify second luminaires 30 from second luminaires 30, and further obtains the setup information in which the DMX addresses and the unique IDs are linked in accordance with an operation of second console 10.

In the illumination system according to the present embodiment, second luminaires 30 are connected to second information processing device 20 that generates the setup information. Second information processing device 20 communicates with second luminaires 30 using the RDM protocol when linking the DMX addresses and the unique IDs of second luminaires 30. Second console 10 communicates with each of second luminaires 30 using a DMS protocol when turning on each of second luminaires 30 based on the setup information.

The illumination system according to the present embodiment further includes second information processing device 20.

These illumination systems also produce the same advantageous effects as the above embodiment.

In the illumination system according to the above embodiment, the second console and the second information processing device are separate devices, but may also be integrated to each other.

The illumination system and the method for setting up the illumination system according to the above embodiment may be implemented as a computer program, and may also be implemented as a large-scale-integrated (LSI) circuit. The integrated circuit (IC) may be realized as one chip, or may be realized as one chip including a portion or the entirety of the IC.

The means for realizing the integrated circuit (IC) is not limited to LSI, but may also be realized by a dedicated circuit or a general-purpose processor. After manufacturing the LSI, a field-programmable gate array (FPGA) that can be programmed or a reconfigurable processor whose settings and connections of circuit cells in the LSI can be reconfigured may also be used.

Note that in the above embodiment, each component may be realized by being dedicated hardware or being executed by a software program suited to each component. Each component may also be realized by a program executor, e.g. a central processing unit (CPU) or a processor reading and executing a software program stored on a recording medium, e.g. a hard disk, semiconductor memory, or the like.

Numbers used above are exemplified for concretely describing the entire present disclosure, but the numbers in the embodiments in the present disclosure are not limited to the foregoing.

The segmentation of the function blocks in the block diagrams is an example, and multiple function blocks may be implemented as one function block, one function block may be divided into multiple function blocks, and partial functionality may be moved to another function block. Functionality of multiple function blocks having similar functionality may be processed in parallel or using time-sharing by a single hardware device or software.

The order of in the steps in the flowcharts are executed are exemplified for concretely describing the present disclosure and may also be different from the foregoing. A portion of the above steps may be executed simultaneously with (in parallel) other steps.

Additionally, forms realized by optionally combining components and functions in the embodiments that can be conceived by a person skilled in the art which are within the scope of the essence of the present disclosure are also included in the scope of the present disclosure.

While the foregoing has described one or more embodiments and/or other examples, it is understood that various modifications may be made therein and that the subject matter disclosed herein may be implemented in various forms and examples, and that they may be applied in numerous applications, only some of which have been described herein. It is intended by the following claims to claim any and all modifications and variations that fall within the true scope of the present teachings.

What is claimed is:

1. An illumination system that uses information from a first information processing device that (i) disposes a plurality of first luminaires that are virtual, (ii) virtually simulates a lighting mode for each of the plurality of first luminaires, and (iii) generates lighting information indicating the lighting mode for each of the plurality of first luminaires and first address information that is linked to the lighting information and identifies each of the plurality of first luminaires, the illumination system comprising:
a plurality of second luminaires disposed in an actual facility; and
a console that turns on each of the plurality of second luminaires in a predetermined lighting mode, wherein
the console:
obtains the lighting information, the first address information, and second address information that identifies each of the plurality of second luminaires; and
further obtains setup information in which the first address information and the second address information are linked.

2. The illumination system according to claim 1, wherein
in the setup information, the first address information and the second address information are linked by a user input so that the plurality of first luminaires and the plurality of second luminaires are associated one-to-one.

3. The illumination system according to claim 1, further comprising:
a second information processing device connected to the plurality of second luminaires, wherein
the second information processing device generates the setup information,
the second information processing device communicates with each of the plurality of second luminaires using a Remote Device Management (RDM) protocol when the first address information and the second address information are linked with respect to each of the plurality of second luminaires, and
the console communicates with each of the plurality of second luminaires using a Digital Multiplex (DMX) protocol when turning on each of the plurality of second luminaires based on the setup information.

4. The illumination system according to claim 3, further comprising:
the second information processing device that generates the setup information, in which the first address information and the second address information are linked, by a user input so that the plurality of first luminaires and the plurality of second luminaires are associated one-to-one.

5. The illumination system according to claim 1, wherein
the console turns on the plurality of second luminaires based on the setup information so that the plurality of first luminaires are turned on in a virtual lighting mode.

6. The illumination system according to claim 1, wherein
the illumination system is connected to a display, and
the display displays a setup image for linking the first address information and the second address information.

7. The illumination system according to claim 1, further comprising:
the first information processing device.

8. An illumination system, comprising:
a first information processing device that disposes a plurality of first luminaires that are virtual on a screen, and virtually simulates a lighting mode for each of the plurality of first luminaires;
a plurality of second luminaires disposed in an actual facility; and
a console that turns on each of the plurality of second luminaires in a predetermined lighting mode, wherein
the first information processing device obtains (i) lighting information indicating the lighting mode for each of the plurality of first luminaires, (ii) and first address information that is linked to the lighting information and identifies each of the plurality of first luminaires, and
the console:
obtains the lighting information and the first address information from the first information processing device, and second address information that identifies each of the plurality of second luminaires from the plurality of second luminaires; and
further obtains, in accordance with an operation via the console, setup information in which the first address information and the second address information are linked.

9. The illumination system according to claim 8, wherein:
the plurality of second luminaires are connected to a second information processing device that generates the setup information,
the second information processing device communicates with each of the plurality of second luminaires using a Remote Device Management (RDM) protocol when the first address information and the second address information are linked with respect to the plurality of second luminaires, and
the console communicates with each of the plurality of second luminaires using a Digital Multiplex (DMX) protocol when turning on the plurality of second luminaires based on the setup information.

10. The illumination system according to claim 8, further comprising:
a second information processing device.

11. An illumination system that uses, through a computer, specification information including (i) lighting information that indicates a lighting mode for each of a plurality of first luminaires that are virtual and (ii) first address information that identifies each of the plurality of first luminaires, the illumination system comprising:
a plurality of second luminaires disposed in an actual facility; and
a console that turns on each of the plurality of second luminaires in a predetermined lighting mode, wherein
the computer:
disposes the plurality of first luminaires in a virtual space;
generates the lighting information by virtually simulating the lighting mode for each of the plurality of first luminaires in the virtual space; and
generates the first address information by linking the lighting information and the plurality of first luminaires that use the lighting information, and
the console:
obtains the lighting information, the first address information, and second address information that identifies each of the plurality of second luminaires from the computer; and
further obtains setup information, in which the first address information and the second address information are linked, so that an operation of each of the plurality of first luminaires and an operation of each of the plurality of second luminaires are associated with each other.

12. A method for setting up an illumination system, comprising:
disposing a plurality of first luminaires that are virtual;
virtually simulating a lighting mode for each of the plurality of first luminaires;
using information from a first information processing device that generates lighting information indicating the lighting mode for each of the plurality of first luminaires and first address information that is linked to the lighting information and identifies each of the plurality of first luminaires;
turning on a plurality of second luminaires that are disposed in an actual facility in a predetermined lighting mode;
obtaining the lighting information, the first address information, and second address information that identifies each of the plurality of second luminaires; and
further obtaining setup information in which the first address information and the second address information are linked.
